(19) United States
(12) Patent Application Publication
(10) Pub. No.: US 2009/0126222 A1
(43) Pub. Date: May 21, 2009

(54) Dryer

(75) Inventors: Sang Hun Bae, Changwon-si (KR); Chang Woo Son, Changwon-si (KR); Yeon Sik Choi, Changwon-si (KR); Ju Han Yoon, Changwon-si (KR); Dong Geun Lee, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/155,682

(22) Filed: Jun. 6, 2008

(30) Foreign Application Priority Data
Jun. 8, 2007 (KR) 10-2007-0055972
Nov. 21, 2007 (KR) 10-2007-0119313

(51) Int. Cl. F26B 19/00

(52) U.S. Cl. 34/527

(57) ABSTRACT

A laundry machine, in particular, a dryer using steam, is disclosed. The dryer includes an object container for containing an object, a control panel provided as a user interface, and a controller. In the dryer, the control panel comprises a course selector for enabling a user to select one of a steam-enable course, in which a steam cycle for supply steam to the object container is enabled, a steam course, in which the steam cycle is provided, and a steam-off course, from which the steam cycle is excluded, as operation courses. The controller controls an operation of the dryer to execute the selected operation course.

This application claims the benefit of Korean Patent Applications No. 10-2007-0055972, filed on Jun. 8, 2007 and No. 10-2007-0119313, filed on Nov. 21, 2007, which are hereby incorporated by references as if fully set forth herein.

### BACKGROUND OF THE INVENTION

1. Field of the Invention

The present invention relates to a laundry machine, and more particularly to a dryer using steam.

2. Discussion of the Related Art

A laundry machine is an appliance for washing or drying an object such as laundry. Such a laundry machine includes a washing machine, a drying machine, or a washing machine having a drying function. Recently, a product, in which a steam generator is added to a washing machine, in particular, a drum washing machine, to supply steam to laundry, and thus to achieve an enhancement in washability and a reduction in energy consumption, has been highlighted. Also, dryers are increasingly distributed, not only to achieve an enhancement in boiling quality, but also to artificially dry washed laundry, in place of natural drying.

However, conventional dryers have a simple function for drying laundry. For this reason, they have been required to perform additional functions, in addition to the laundry drying function. For example, such conventional dryers have a problem in that wrinkles are formed on laundry after the completion of a drying operation for the laundry, so that it is necessary to perform a separate ironing operation.

In addition, it is necessary to enable the user to easily use the additional functions provided to the above-mentioned dryers. This is because, even though the additional functions are excellent, if the user cannot easily use the additional functions, the user will only use the simple drying function.

Typically, a dryer includes a control panel provided as a user interface. The user not only inputs a variety of information through the control panel, but also obtains a variety of information through the control panel.

Therefore, it is necessary to enable the user to easily select a drying function and additional functions through the control panel. It is also necessary to provide a dryer enabling the user to easily use the drying function and additional functions without any confusion, even when the drying function is related to the additional functions.

In order to execute the additional functions under optimal conditions, it is also necessary to appropriately control the operation of the dryer. This is also associated with a reduction in energy consumption.

### SUMMARY OF THE INVENTION

Accordingly, the present invention is directed to a dryer that substantially obviates one or more problems due to limitations and disadvantages of the related art.

An object of the present invention is to provide a dryer, which has, in addition to a general drying function, an additional function to enhance ease of use.

Another object of the present invention is to provide a dryer, which has a wrinkle removing function, a static electricity removing function, or an easy ironing function, to enhance ease of use.

Another object of the present invention is to provide a dryer, which enables the user to easily select a drying function or an additional function, and thus to conveniently use the dryer.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dryer comprises an object container for containing an object, a control panel provided as a user interface, and a controller, wherein the control panel comprises a course selector for enabling a user to select one of a steam-enable course, in which a steam cycle for supply steam to the object container is enabled, a steam course, in which the steam cycle is included, and a steam-off course, from which the steam cycle is excluded, as operation courses, wherein the controller controls an operation of the dryer to execute the selected operation course.

The control panel may comprise an option selector for enabling the user to select an option course, in which the steam cycle is included, in addition to the operation course.

That is, under the condition in which the steam course is selected, the steam cycle is executed, even when no option course is selected. For the steam course, various courses may be provided in accordance with the functions and effects of a main course.

Also, when the steam-enable course is selected, but the option course is not selected, the steam-enable course is executed under the condition in which no steam cycle is executed. For the steam-enable course, various courses may be provided in accordance with the functions and effects of the main course. For example, the steam-enable courses may comprise various courses for drying clothes exhibiting a reduced possibility of damage by heat.

When the steam-enable course is selected, and the option course is selected, they may be executed in a sequential or simultaneous manner. When the steam-off course is selected, it is executed irrespective of the selection of the option course. In this case, no steam cycle is executed. The steam-off course may comprise courses for drying clothes exhibiting susceptible to heat damage.

Thus, the dryer according to the present invention can execute various additional functions using steam. Such additional functions may be executed in accordance with the selection of the operation course, or may be executed in accordance with the selection of both the operation course and the option course.

The steam-enable course may include a drying cycle for supplying hot air to the object container, to dry the object, and a cooling cycle for supplying cold air to the object container, to cool the object.

When the steam-enable course is selected, and the option course is selected, the controller may control the option course to be executed during the drying cycle or during the cooling cycle. When the steam-enable course is selected, and the option course is selected, the controller may also control the option course to be executed after a completion of the steam-enable course.

The option selector may select a plurality of option courses in accordance with functions or purposes to be achieved using steam, or may select one of the option courses. For example, the option selector may comprise a button for selecting an option to execute the option course during the steam-enable course, and a button for selecting an option to execute the steam cycle after the completion of the steam-enable course.

The steam-enable course may be controlled to be executed under a condition in which an operation condition of the drying cycle is varied in accordance with a drying degree sensed during the drying cycle. The operation condition may include at least one of a drying cycle time, an internal temperature of a drum, and a capacity of a heater to heat air supplied to the interior or the drum.

For example, the operation condition may be a time taken for the drying cycle. When the drying degree exhibited in accordance with the execution of the drying cycle is higher than a predetermined drying degree, the drying cycle time is correspondingly reduced. On the other hand, in an opposite case, the drying cycle time is increased. Accordingly, it is possible to achieve optimal drying, and thus to prevent the object from being damaged due to over-drying, and to prevent the user from feeling discomfort due to insufficient drying.

The amount of the object (laundry amount) may be determined, based on the drying degree sensed during the drying cycle. When the laundry amount is large, the drying degree will be lower than an expected drying degree, and the time taken for the drying cycle will be increased. On the other hand, when the laundry amount is small, the drying degree will be higher than the expected drying degree, and the time taken for the drying cycle will be reduced. That is, the drying degree sensed during the drying cycle is varied in accordance with the laundry amount. Accordingly, it is possible to determine the laundry amount, based on the sensed drying degree.

Meanwhile, it is preferred that the point of time when the heater operates to generate steam be varied in accordance with the determined object quantity. This is because the point of time when the drying cycle is ended may be varied in accordance with the laundry amount, and the point of time when the heater operates may be varied in accordance with the end point of the drying cycle. It is also preferred that the operation time of the heater be varied in accordance with the determined object quantity. The operation time of the heater is associated with the amount of steam supplied to the drum. That is, when the operation time of the heater increases, the execution time of the steam cycle increases. In this case, accordingly, the amount of supplied steam increases.

The steam course may include a drying cycle for supplying hot air to the object container, to dry the object, and the steam cycle. The steam course may be controlled to be executed under a condition in which no variation in a predetermined operation condition of the drying cycle occurs during the drying cycle. This is because the steam course may be a course executed for dry clothes as the object or a course executed such that the object has a certain moisture content after the completion of the course. That is, the drying of clothes to an optimal drying degree in the dying cycle such that the clothes may be unnecessary or may cause waste of energy.

When the steam course is selected, the option course may be disabled so that the option course cannot be selected. When the user selects the option course, he may be audibly informed of the fact that the option course cannot be selected. Also, it may be possible to visually inform the user of the fact that the option course cannot be selected, by maintaining an LED in an OFF state. Of course, it is possible to inform the user of the fact that the option course can be selected, by turning on the LED.

The steam course may comprise a course in which the steam cycle is executed after a completion of the drying cycle such that the object has a moisture content of 5 to 6%. After a main steam course is completed, the steam cycle is executed such that the object has a moisture content of 5 to 6%. The moisture content corresponds to a uniformly-dampened state of the object enabling the user to easily iron the object. Through this course, accordingly, the user can perform an easy ironing operation. This course may be referred to as an “easy ironing course”.

The steam course may comprise a course in which a drying cycle is executed after a completion of the steam cycle for the object, which is in a dry state. Here, the object, which is in a dry state, means laundry not washed, in particular, an object, which is in a non-contaminated state, but is required to be subjected to a treatment for removal of odor or wrinkles. The object may also mean an object, which is required to be subjected to the odor or wrinkle removing treatment as it is disposed in the drum for a long period of time after the completion of the drying thereof. Through this course, accordingly, it is possible to easily remove odor or wrinkles from the clothes without performing an additional washing operation. This course may be referred to as a “steam fresh course” or a “refresh course”.

When the steam-executing course is selected, the option course may be disabled so that the option course cannot be selected. This is because, when the steam cycle is executed in the steam-off course, the object may be damaged by heat. Also, the user may be injured when he erroneously operates the dryer.

The amount of steam supplied to the object in the steam cycle may be controlled to vary in accordance with an amount of the object. Of course, steam may be supplied to the object in a predetermined amount, irrespective of the amount of the object. In order to enable the object to have an optimal moisture content in accordance with each function, however, it is preferred that the amount of steam be increased when the amount of the object increases.

The control panel may further comprise a button for selecting the amount of steam supplied to the object in the steam cycle, or a button for inputting information as to the object quantity.

In the steam cycle, steam is supplied to the drum. However, the steam cycle is not limited to this condition. That is, the steam cycle may supply fine moisture to the interior of the drum, along with hot air, in place of steam.

The control panel may further comprise prints for visually distinguishing the steam-enable course, the steam course, and the steam-off course from one another. The controller may control the operation of the dryer such that the selected operation course and the selected option course are executed in a sequential or simultaneous manner.

It is to be understood that both the foregoing general description and the following detailed description of the present invention are exemplary and explanatory and are intended to provide further explanation of the invention as claimed.

In accordance with the present invention, it is possible to provide a dryer, which has, in addition to a general drying function, an additional function to enhance ease of use.

In accordance with the present invention, it is possible to provide a dryer, which has a wrinkle removing function, a static electricity removing function, or an easy ironing function, to enhance ease of use.

In accordance with the present invention, it is possible to provide a dryer, which enables the user to easily select a drying function or an additional function, and thus to conveniently use the dryer.

In accordance with the present invention, it is possible to provide a dryer, which enables the user to easily select a general drying function and an additional function using steam, and thus to conveniently use such functions.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exploded perspective view of a dryer according to an exemplary embodiment of the present invention;

FIG. 2 is a sectional view illustrating the dryer according to the illustrated embodiment of the present invention;

FIG. 3 is a view illustrating a steam generator used in the dryer of FIG. 2;

FIG. 4 is a perspective view partially illustrating a dryer according to another embodiment of the present invention; and

FIG. 5 is a view illustrating an exemplary embodiment of a control panel for use in the implementation of the present invention.

### DETAILED DESCRIPTION OF THE INVENTION

Reference will now be made in detail to the preferred embodiments of the present invention associated with a dryer, examples of which are illustrated in the accompanying drawings.

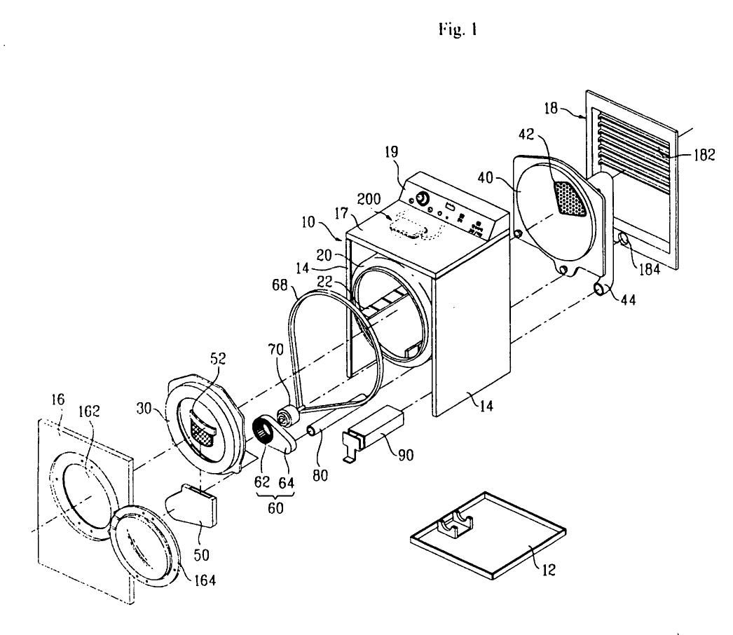

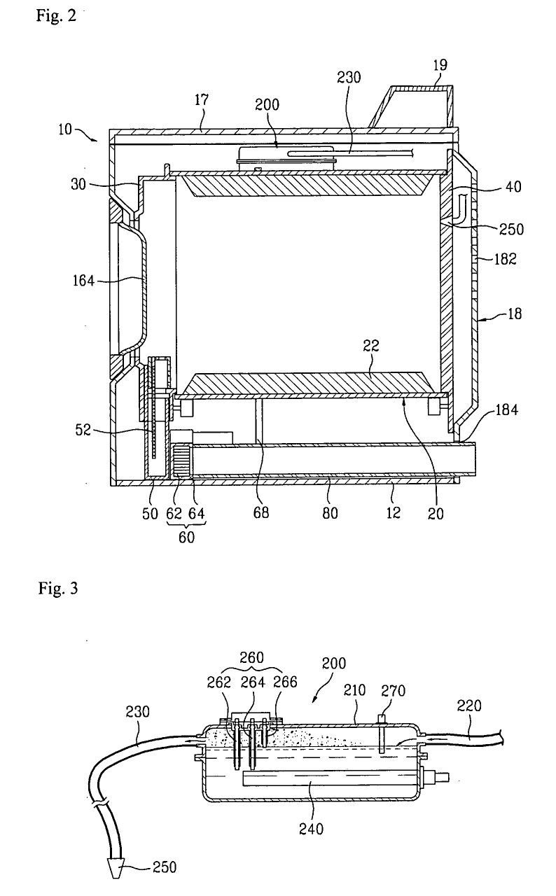

Hereinafter, an exemplary embodiment of a dryer according to the present invention will be described with reference to FIGS. 1 and 2. For convenience of description, the following description will be given in conjunction with a top loading, electrical, exhaustion type dryer. Of course, the present invention is not limited to such a dryer.

The dryer according to the illustrated embodiment of the present invention includes a cabinet 10 forming an outer appearance of the dryer, and a drum 20 rotatably installed in the cabinet 10. The dryer also includes an air supplier to supply hot air or cold air to the interior of the drum 20. The dryer further includes a motor 70 and a belt 68 to drive the drum 20. In the drum 20, an object to be dried will be received.

The air supplier includes an air heater 90 arranged in the cabinet 10 at a desired position, to heat air, and thus to generate hot air, and a hot air supply duct 44 arranged in the cabinet 10, to supply the hot air generated by the air heater 90 to the drum 20. The air supplier also includes an exhaust duct 80 for exhausting humid air heat-exchanged with an object to be dried in the drum 20, and a blower unit 60 for expelling the humid air. In the case of a condensation type dryer, a condensing duct and a condenser may be provided to condense humid air heat-exchanged with an object to be dried.

A steam supplier is arranged in the cabinet 10 at an appropriate position. The steam supplier generates steam, and supplies the generated steam to the interior of the drum 20. The steam supplier includes a steam generator 200 for heating water, to generate hot steam.

Although an indirect drive type, in which the motor 70 and belt 68 are used to rotate the drum 20, is illustrated and described in this embodiment, the present invention is not limited thereto. That is, a direct drive type, in which a motor is directly connected to a rear wall of the drum 20, to directly rotate the drum 20, may be applied to the present invention.

Hereinafter, the above-described constituent elements will be described in more detail.

The cabinet 10, which forms the outer appearance of the dryer, includes a base 12 forming a bottom wall, a pair of side covers 14 extending vertically from the base 12, front and rear covers 16 and 18 respectively mounted to front and rear ends of the base 12, and a top cover 17 disposed on the upper ends of the side covers 14. A control panel 19, which includes operating switches, etc., may be arranged on the top cover 17 or front cover 16. A louver 182 is provided at the rear cover 18, to introduce ambient air into the cabinet 10. An exhaust hole 184 is also provided at the rear cover 18, as a passage for finally discharging air from the drum 20 to the outside of the drum 20.

The inner space of the drum 20 functions as a drying chamber in which drying is carried out. Lifts 22 are installed in the drum 20.

A front supporter 30 and a rear supporter 40 are installed between the drum 20 and the cabinet (between the front cover 16 and the rear cover 18). The drum 20 is rotatably supported between the front supporter 30 and the rear supporter 40. Sealing members (not shown) are fitted between the front supporter 30 and the drum 20 and between the rear supporter 40 and the drum 20, respectively, to prevent water leakage. That is, the front supporter 20 and rear supporter 40 close the front and rear sides of the drum 20, respectively, to define the drying chamber. The front supporter 20 and rear supporter 40 also function to support the front and rear ends of the drum 20.

An opening 162 is formed through the front supporter 30, to communicate the drum 20 with the outside of the dryer. The opening 162 is selectively opened or closed by a door 164. A lint duct 50, which is a passage for outwardly discharging air from the drum 20, is connected to the front supporter 30. A lint filter 52 is installed in the lint duct 50. One side of the blower unit 60 is connected to the lint duct 50. The other side of the blower unit 60 is connected to the exhaust duct 80. The exhaust duct 80 communicates with an exhaust hole 184 provided at the rear cover 18. Accordingly, when the blower unit 60 operates, air present in the drum 20 is exhausted from the drum 20 via the lint duct 50, exhaust duct 80, and exhaust hole 184. During this operation, foreign matter such as lint is filtered out by the lint filter 52. Typically, the blower unit 60 includes a blower 62, and a blower housing 64. Typically, the blower 62 is connected to the motor 70, which drives the drum 20.

An inlet port 42, which is constituted by a plurality of through holes, is formed through the rear supporter 40. A hot air supply duct 44 is connected to the inlet port 42. The hot air supply duct 44 communicates with the drum 20 via the inlet port 42 of the rear supporter 40, to function as a passage for supplying hot air to the drum 20. To this end, the air heater 90 is installed at a certain position in the hot air supply duct 44.

Hereinafter, a detailed configuration of the steam generator 200 will be described with reference to FIG. 3.

The steam generator 200 includes a water tank 210, in which water is stored, a heater 240 mounted in the water tank 210, a water level sensor 260 for measuring the water level of the water tank 210, and a temperature sensor 270 for measuring the temperature of the water contained in the water tank 210.

Typically, the water level sensor 260 includes a common electrode 262, a low-water-level electrode 264, and a high-water-level electrode 266. A low water level or a high water level is sensed in accordance with whether the common electrode 262 is electrically connected with the low-water-level electrode 264 or with the high-water-level electrode 266.

A water supply line 220, which extends from a water container, is connected to one side of the steam generator 200, to supply water to the steam generator 200. The water container will be described later. A steam line 230 is connected to the other side of the steam generator 200, to discharge steam from the steam generator 200. Preferably, a nozzle 250 is arranged at an end of the steam line 230 opposite to the steam generator 200, to spray steam, in order to achieve an enhancement in steam spraying efficiency.

Thus, steam is supplied to the interior of the drum 20 via the steam supplier, which includes the above-described steam generator 200, in accordance with the present invention.

The steam generator 200 may have a configuration different from the above-described configuration. For example, the steam generator 200 may be configured to heat water flowing through a pipe-shaped housing (not shown), for the generation of steam, without heating water contained in the water tank 210. For convenience of description, the former steam generator will be referred to as a “barrel type steam generator”, and the latter steam generator will be referred to as a “pipe type steam generator”.

The pipe type steam generator can greatly reduce the time taken to generate steam, as compared to the barrel type steam generator, because the pipe type steam generator generates steam by rapidly heating water. In the pipe type steam generator, however, there may be a problem in that hot water other than steam may be supplied to the interior of the drum. As compared to the pipe type steam generator, the barrel type steam generator has an advantage in that it is possible to stably supply steam to the interior of the drum.

Hereinafter, effects obtained when the dryer uses steam will be described in brief.

Typically, the dryer dries an object to be dried, using hot air. However, wrinkles or creases may be formed on the object as the drying operation proceeds. For this reason, an ironing operation may be required after the object is completely dried. However, it is possible to reduce or eliminate the formation of such wrinkles or creases by supplying steam to the object during the drying operation. That is, when steam is supplied to a wrinkled or creased portion of the object, to supply moisture to the wrinkled or creased object portion, and the object is then dried using hot air, wrinkles or creases from the wrinkled or creased object portion are removed as the moisture is evaporated by the hot air. Accordingly, it may be preferred that the supply of the steam be initiated after the object is dried to some degree in accordance with the drying operation.

Meanwhile, steam is composed of fine hot water particles having a particle size of several microns. Accordingly, such steam supplies moisture and extreme heat to the object to be dried, thereby removing odor particles from the object. Thus, it is possible to effectively remove odor through a dryer using steam.

Also, it is possible to supply a certain amount of moisture to the object to be dried, namely, laundry, using steam, before the completion of the drying operation. Of course, the supply of moisture in a certain amount using steam may be carried out after the completion of the drying operation. As moisture is uniformly supplied to the laundry, using steam, it is possible to prevent the laundry from accumulating a static charge when the user unloads the laundry from the drum, and thus to prevent the user from feeling discomfort due to static electricity.

Here, steam is a medium for supplying moisture and extreme heat to the object to be dried. Since steam takes the form of very fine particles, as described above, it can effectively penetrate the object. Accordingly, moisture can be uniformly absorbed into the entirety of the object. In other words, it is possible to effectively prevent moisture from being excessively absorbed into only a particular portion of the object.

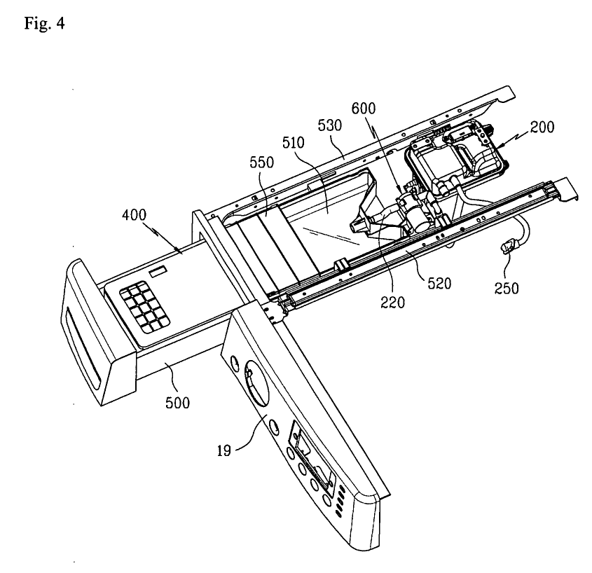

FIG. 4 illustrates an embodiment in which the steam generator 200 is configured such that no external supply source is connected to the steam generator 200, and the user directly pours water into the steam generator 200. In accordance with this configuration, the dryer, which uses steam, can be conveniently used in environments in which it is difficult to provide water supply and water drainage facilities. Of course, water can be supplied to the steam generator via an external water supply tap, as in general washing machines.

Hereinafter, a configuration for supplying water to the steam generator 200 in accordance with an exemplary embodiment of the present invention will be described.

Preferably, a drawer type container 500 (hereinafter, referred to as a “drawer”) is installed at a desired position in the dryer according to the present invention such that the drawer 500 can be slidably inserted/ejected. Preferably, a tank 400 is mounted to the drawer 500. The tank 400 functions as a water container for containing water. Accordingly, water contained in the water container, namely, the tank 400, is supplied to the steam generator 200.

In this case, it is preferred that the tank 400 be mounted to the drawer 500 such that it can be indirectly connected to or disconnected from the water supply line 220 in accordance with the insertion or ejection of the drawer 500, as compared to a structure in which the tank 4000 is directly connected to the water supply line 220. This is because the amount of water used in the dryer is very small, as compared to washing machines, and the dryer can be used in environments in which it is difficult to provide a water supply facility such as city water service.

It is also preferred that the drawer 500 be arranged at the front side of the dryer, namely, at the front side of the cabinet 10. In particular, it is preferred that the drawer 500 be arranged at the control panel 19.

In detail, a supporter 520 is installed in the rear of the control panel 19. In this case, it is preferred that the supporter 520 be arranged to be substantially parallel to a top frame 530. It is also preferred that a drawer guide 510 be arranged between the supporter 520 and the top frame 530, to guide and support the drawer 500. It is also preferred that a top guide 550 be arranged on a portion of the upper surface of the drawer guide 510.

The drawer guide 510 is open at the upper surface thereof and one side surface thereof (corresponding to the front side of the dryer). The drawer 500 can be inserted/ejected through the opening.

Meanwhile, in this embodiment, it is preferred that the tank 400, which supplies water to the steam generator 200, be configured to be separable from the steam generator 200. This is convenient in the case in which the separable tank 400 is used in such a manner that water is supplied to the tank 400 in a separated state of the tank 400, and the water-filled tank 400 is then connected to the water supply line 220 of the steam generator 200, as in the present embodiment.

Preferably, a pump 600 is arranged between the tank 400 and the steam generator 200. More preferably, the pump 600 is rotatable in normal and reverse directions, not only to supply water to the steam generator 200, but also to recover residual water from the steam generator 200, if necessary.

Thus, it can be understood that the steam supplier according to the present invention includes the steam generator 200, which generates steam, the pump 600, which pumps water contained in the tank 400, to supply the water to the steam generator 200, and the nozzle 250, which supplies steam generated in the steam generator 200 to the interior of the drum 20.

The water supply line 220, which supplies water, is arranged between the tank 400 and the steam generator 200. The steam line 230 is arranged between the steam generator 200 and the nozzle 250. The lines 220 and 230 may have a pipe structure.

Although the configuration, in which steam is supplied to the interior of the drum, has been described in the above-described embodiment, the present invention is not limited thereto.

For example, the configuration of the steam generator 200 for generating steam may be dispensed with in the above-described embodiment. For example, the dryer may be configured to supply fine moisture, namely, mist, to the interior of the drum, in place of steam.

That is, when water contained in a water container 401 is pumped by the pump 600, a water pressure is generated. When the water passes through the nozzle 250 under pressure, it is changed into mist which is, in turn, supplied to the interior of the drum 20. In order to supply mist, the nozzle 250 may have a structure different from the above-described steam-supplying nozzle structure. Of course, the water pressure may be the water pressure of the external water supply tap. Where the dryer is connected to the external water supply tap, the configuration of the pump 600 can be dispensed with. This can also be possible in the case in which the steam generator 200 is used.

The temperature of the mist is not high because the mist is formed as water of ambient temperature is sprayed. Also, the particle size of the mist may be several tens of microns. For this reason, the mist may be supplied to a particular portion of the object, without being uniformly supplied to the entirety of the object, as compared to steam. Furthermore, there may be a possibility that the mist cannot be deeply penetrated into the object.

In order to eliminate this possibility, it is necessary to heat the mist to a high temperature. That is, it is necessary to make the mist similar to the above-described steam as much as possible.

As described above, the dryer includes the air supplier to supply hot air or cold air to the interior of the drum. In this regard, it is preferable to control the air supplier such that the air supplier operates to supply hot air to the drum when the mist is supplied to the drum. In this case, the mist is heated, so that it is partially vaporized. As a result, the particle size of the mist is reduced. In addition, as the temperature of the mist increases, moisture can be uniformly and deeply absorbed into the object. In order to obtain a more effective synergy of the mist with hot air, it is preferred that the position of the nozzle 250, from which the mist is sprayed, be approximate to the position of the inlet port 42, through which hot air is introduced into the drum.

That is, the nozzle 250, which supplies mist to the interior of the drum, may be provided at the rear supporter 40 such that the nozzle 250 is arranged near the inlet port 42.

Of course, the nozzle 250 may be arranged in the hot air supply duct 44. In this case, the mist may be supplied to the interior of the drum through the inlet port 42, together with hot air, after being heated in the hot air supply duct 44.

Hereinafter, the control panel 19, which is provided as a user interface, will be described.

The control panel 19 includes a course selector 610, a power button 620, and a start button 621. The user can select a desired one from a plurality of operating courses through the course selector 610.

The course selector 610 includes a steam course 613, a steam-enable course 611, and a steam-off course 612. Each of these courses may include a plurality of courses. Here, the steam course 613 is a course including a steam cycle for supplying steam to the drum. The steam-enable course 611 is a course in which the execution of the steam cycle is enabled. The steam-off course 612 is a course in which no steam cycle is executed.

When a desired course is selected through the course selector 610, a controller controls the operation of the dryer in accordance with the selected course.

The control panel 19 also includes an option selector 630 for selecting an option course, which includes the steam cycle, in addition to the selected operating course.

The control panel 19 may further include various prints 614. The prints 614 may be characters printed on the buttons, or characters printed around the course selector 610. The user can identify the course or option to be input, through the prints. Through the prints, the user can also easily check whether the current course includes the steam cycle or corresponds to the steam-enable course, or whether or not a drying degree is sensed, for the execution of an optimal drying operation or the execution of an additional function.

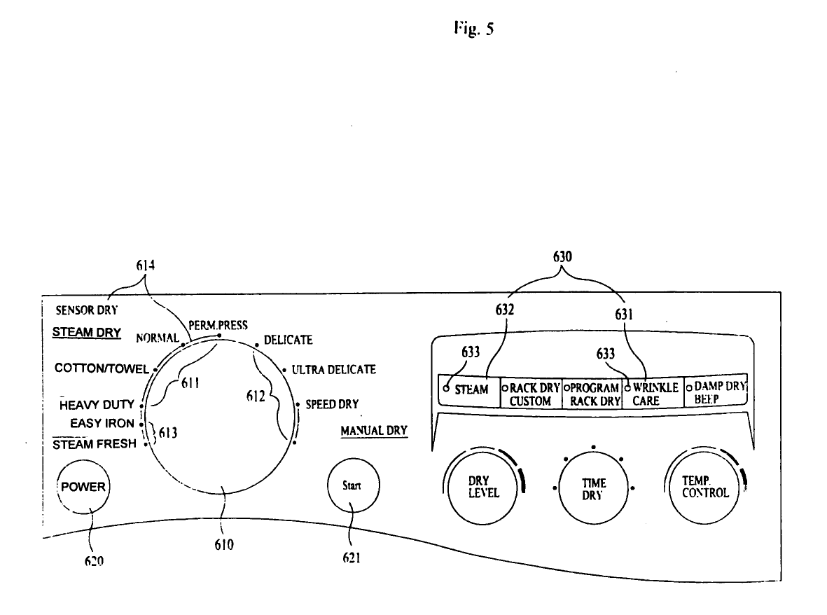

Hereinafter, the selection and control of the drying function and additional functions provided in the dryer according to the present invention, through the control panel shown in FIG. 5, will be described in detail.

The user can select the steam-enable course 611 through a course input unit, namely, the course selector 610. Here, the term “steam-enable course” refers to a course, in which the steam cycle can be selectively included. The inclusion of the steam cycle can be selected by the user through the option selector 630.

For example, the steam-enable course 611 may include various courses in accordance with the types of clothes exhibiting a reduced possibility of damage by heat. That is, the steam-enable course 611 may include a general drying course, a drying course for drying cotton or towels, and a drying course for drying clothes requiring a long drying time, for example, blue jeans.

Since the steam-enable course 611 is adapted to dry clothes having no possibility of damage by heat, it includes a drying cycle for supplying hot air to the drum, to dry an object, and a cooling cycle for supplying cold air to the drum, to cool the object. The cooling cycle is required to prevent the user from being injured by heat because the interior of the drum and the object are at a high temperature after the execution of the drying cycle. Of course, if the drying cycle is carried out at a low temperature in the final stage of the drying cycle, the cooling cycle may be dispensed with.

On the other hand, when both the steam-enable course 611 and the option course 630 are selected, the controller may control the option course to be executed during the drying cycle or during the cooling cycle. Also, the controller may control the option course to be executed after the completion of the steam-enable course.

The control operation will now be described in detail, in conjunction with the case in which the steam-enable course 613 is a general drying course “Normal”, and the option course 630 is a static electricity removing course (Static Care) 632. In FIG. 5, the static electricity removing course 632 is designated by “STEAM”. Accordingly, the course 632 “STEAM” may also be an option course other than the static electricity removing course.

When only the steam-enable course is selected, static charge may be accumulated in the object dried after the completion of the course, so that the user may feel discomfort due to static electricity. Accordingly, the static electricity removing course may be selected to remove static electricity.

In order to remove static electricity, it is necessary to supply steam to the object, and thus, to impart the object with a certain moisture content. It is preferred that the steam cycle be executed after the completion of the drying cycle. Of course, the steam cycle may be executed during the cooling cycle or after the completion of the cooling cycle. That is, the object dried through the drying cycle has a certain moisture content in the cooling cycle or in the steam cycle executed after the completion of the cooling cycle. Accordingly, it is possible to minimize the discomfort to the user caused by static electricity.

It is preferable to control the amount of steam supplied to the object, in order to remove or reduce static electricity. This is because, when steam is supplied in an excessive amount, the object is excessively dampened, so that a re-drying operation may be required. Therefore, it is preferable to control the amount of supplied steam such that the object has a moisture content of 5% or less.

Hereinafter, the control operation will be described in detail, in conjunction with the case in which the steam-enable course 611 is a cotton/towel course “Cotton/Towel”, and the option course 630 is a wrinkle removing course 631 “Wrinkle Care”.

In this case, the steam cycle may be executed in the final stage of the drying cycle. That is, the drying cycle is executed to dry the object, and the steam cycle is executed in the final stage of the drying cycle, to uniformly supply steam to the dried object. Even after the completion of the steam cycle, the drying cycle is continuously executed, in order to remove wrinkles. Of course, the steam cycle may be executed after the completion of the drying cycle. In this case, the drying cycle may be again executed after the completion of the steam cycle.

Meanwhile, it is preferred that, in the wrinkle removing course 631, the drying cycle be executed after the steam cycle. This is because, in order to remove wrinkles, it is necessary to supply an increased amount of steam to the object, as compared to the steam amount used to remove static electricity. To this end, it is necessary to dry the object through the drying cycle, after the completion of the steam cycle. In this case, it is possible to enhance the wrinkle removing effect, using hot air.

The option course 630 may be repeatedly selected such that two or more option courses can be executed. For example, the static electricity removing course 632 and the wrinkle removing course 631 may be selectively selected or simultaneously selected. In this case, the steam cycle may be executed several times. Of course, the point of time when the steam cycle is executed may be varied in accordance with the selected option course, in order to achieve a desired function associated with the selected option course.

The selection of the option course 630 may be achieved in accordance with a button pressing operation. For example, for the selection of the option course 630, a single button may be provided. In this case, a desired option course can be selected when the button is repeatedly pressed. Alternatively, buttons to select respective option courses may be provided. In this case, the option course may be executed during the steam-enable course when one particular button is pressed, and may be executed after the completion of the steam-enable course when another particular button is pressed.

It is preferred that the steam-enable course 611 be controlled such that the operation condition of the drying cycle thereof is varied in accordance with a drying degree sensed during the drying cycle. For convenience of description, this drying operation will be referred to as “Sensor dry”. The drying degree is sensed during the drying cycle, in order to obtain an optimal drying effect. Through the sensor dry, it is possible to avoid over-drying or insufficient drying.

Although not shown, the drying degree can be sensed through a humidity sensor provided at the door. The humidity sensor may be an electrode sensor, which determines a drying degree in accordance with a voltage or current generated when the object comes into contact with the electrode sensor. Since the determination of the drying degree through the electrode sensor is well known to persons skilled in the technical field, no detailed description thereof will be given.

When the drying degree obtained in an initial drying cycle having a certain cycle time of, for example, 50 minutes, is higher than a predetermined drying degree, the drying cycle time is correspondingly reduced. On the other hand, in an opposite case, the drying cycle time is increased. In addition to the drying cycle time, the capacity of the heater, which generates hot air, may be varied. Of course, it may also be possible to vary the internal temperature of the drum set to determine whether or not hot air is to be supplied.

Meanwhile, the quantity of objects, namely, the amount of laundry, may be determined in accordance with the drying degree sensed during the drying cycle. The main course is a course for drying laundry maintained in a wet state after being washed. For this reason, where the amount of laundry is large, the drying cycle time is increased. That is, the increase rate of the drying degree exhibited in accordance with the passage of the drying cycle time is low when the amount of laundry is large. On the other hand, in an opposite case, the increase rate of the drying degree is high. Therefore, it is possible to determine the amount of laundry, based on the increase rate of the drying degree.

The steam course 613 is a course, which includes a drying cycle for supplying hot air to the drum, to dry the object, and the steam cycle. That is, when the steam course 613 is selected, the drying cycle is automatically executed. In this course, the operation thereof is controlled in a programmed manner through the steam cycle. In accordance with this control, it is possible to obtain an optimal additional function, in addition to a simple drying function. To this end, it is preferred that, when the steam course 613 is selected, the option course be prevented from being selected. That is, it is preferred that the option selector 630 be deactivated.

The steam course 613 may include an easy ironing course “Easy Iron”. In the easy ironing course, the steam cycle may be executed after the completion of the drying cycle so that the object has a moisture content of 5 to 6%. Thus, after the completion of this course, the object contains a moisture content enabling an easy ironing operation.

The steam course 613 may also include a refresh course or a steam fresh course “Steam Fresh”. The steam fresh course has a feature in that it is carried out for dry objects. That is, the steam fresh course may be executed to easily remove odor or dust from dry clothes. Accordingly, the drying cycle, which is executed in an early stage of the steam course 613, may be dispensed with. In place, the steam course 613 may additionally include a cycle for supplying hot air or cold air to the drum, to remove dust. In this course, the steam cycle is also executed. In accordance with the steam cycle, hot steam is supplied to the object. Accordingly, it is possible to effectively remove wrinkles and odor. In addition, an effect of making clothes soft and moistureless can be expected. It is preferred that, in the steam course 613, steam be supplied to the object such that the object has a moisture content of 66 or more, in order to remove odor and wrinkles. Therefore, it is preferred that the drying cycle be executed after the steam cycle. This is because this course serves to treat a dry cloth so that the user can wear the treated cloth without any further treatment. It is also preferred that the drying cycle be controlled to be executed only for a short time, because the drying cycle is used to remove a small amount of moisture.

As described above, the steam course basically serves to prevent the object from being completely dried, or serves to treat a dry object. Accordingly, it is preferred that, in the steam course, the drying cycle be executed in accordance with a program set in an early operation stage, or a predetermined program. That is, it is preferred that the drying cycle be executed without any variation in the predetermined operation conditions of the drying cycle. For example, it is undesirable to vary the execution time of the steam fresh course because the steam fresh course is executed only for a short time. In addition, the sensing of the drying degree may cause unnecessary energy consumption.

The steam-off course 612 refers to a course in which no steam cycle is provided, namely, a course, in which the steam cycle cannot be selected. That is, this course is a course for drying delicate clothes having susceptible to heat damage. It is preferred that, when the steam-off course is selected, the controller perform a control operation to prevent the option course from being selected.

As shown in FIG. 5, the control panel 19 of the dryer may include prints 614 having various shapes in accordance with an embodiment of the present invention.

Where the course selector 610 takes the form of a rotary knob, the user can select a desired course by rotating the rotary knob. As described above, the dryer of the present invention includes various courses set in accordance with the inclusion/exclusion of the steam cycle and the enable/disable condition of the steam cycle.

For example, selection positions for selecting courses, which include or enable the steam cycle, may be provided at the left side of the course selector 60, whereas selection positions for selecting courses, in which no steam cycle is included, may be provided at the right side of the course selector 60. In order to enable the user to more easily identify the selection positions, characters indicating “STEAM DRY” may be printed on the control panel at the left side of the course selector 60. The printed characters “STEAM DRY” may have a particular color. Also, each course included in the course “STEAM DRY” may be indicated by an arc printed with the same color as the printed characters, as shown in FIG. 5. Accordingly, when the course printed with the particular color or indicated by the arc printed with the particular color is selected, the user can easily identify that the selected course is the steam course or the steam enable course.

Meanwhile, it is also preferable to clearly distinguish the steam course from the steam-enable course. For this purpose, the printed characters expressing each steam-enable course and the printed characters expressing the steam course may be printed with different colors, respectively. For example, each steam-enable course may be printed in black, whereas the steam course may be printed in red. Accordingly, the user can easily distinguish the steam course and steam-enable course from each other, through the prints. That is, the user can readily identify the course printed with the black arc and black characters as the steam-enable course, and the course printed with the red arc and red characters as the steam course.

Also, as described above, each course may include sensor dry, in which the drying degree is sensed during the execution of the course, to vary the operation conditions of the course, or may include non-sensor dry, in which the drying degree is not sensed. Accordingly, characters expressing each course, in which the sensor dry is executed, may be printed in the same color as the characters “SENSOR DRY”, as shown in FIG. 5. For example, the characters “SENSOR DRY” may be printed in black, and the characters expressing each course, in which the sensor dry is executed, may also be printed in black. In this case, in association with a course printed with black characters, the user can easily identify, through the black color, that sensor dry is executed.

Thus, the user can select a variety of operation courses through the prints 614 provided such that they are visually distinguished from one another. The user can also readily identify the feature of each operation course. The user can also readily identify, through the prints 614, whether the option course 630 can be selected in association with the steam cycle. Thus, the user can more easily use the dryer. The user can also very easily use various additional functions as well as the drying function.

Although not shown in FIG. 5, a button enabling the user to select the quantity of objects may be provided. Also, a button enabling the user to select the amount of steam to be supplied may be provided. For these selection functions, both buttons may be provided, or only one of the buttons may be provided. In the latter case, when the user selects a large quantity of objects, the controller may increase the amount of steam to be supplied in the steam cycle, in accordance with the selected object quantity.

Light emitting diodes (LEDs) 633 may also be provided at the option selector 630. For example, the LEDs 633 may be provided at respective option buttons 631 and 632. Each LED 633 may be configured to turn on when it is selected, or may be configured to continuously pulse, while turning on when selected. Each LED 633 may also be configured in a manner reverse to the above-described configurations, such that the LED 633 is always in an ON state, but pulses when selected. Of course, each LED 633 may be always in an ON state, but may turn off when selected. Thus, it is preferred that each LED 633 be configured to have different states before and after the selection thereof, to enable the user to visually identify the selection/non-selection.

As described above, the option selection buttons 631 and 632 are activated when the steam-enable course 611 is selected. Accordingly, it is preferred that, when the steam-enable course is selected, each LED 633 be in an ON state or pulse to inform the user of the selectable state of the option selection buttons 631 and 632. Of course, it is also preferred that, when the steam-off course is selected, each LED 633 be in an OFF state, to inform the user of the non-selectable state of the option selection buttons 631 and 632.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A dryer comprising an object container for containing an object, a control panel provided as a user interface, and a controller,
wherein the control panel comprises a course selector for enabling a user to select one of a steam-enable course, in which a steam cycle for supply steam to the object container is enabled, a steam course, in which the steam cycle is included, and a steam-off course, from which the steam cycle is excluded, as operation courses,
wherein the controller controls an operation of the dryer to execute the selected operation course.

2. The dryer according to claim 1, wherein the control panel comprises an option selector for enabling the user to select an option course, in which the steam cycle is included, in addition to the operation course.

3. The dryer according to claim 2, wherein the steam-enable course includes a drying cycle for supplying hot air to the object container, to dry the object, and a cooling cycle for supplying cold air to the object container, to cool the object.

4. The dryer according to claim 3, wherein, when the steam-enable course is selected, and the option course is selected, the controller controls the operation of the dryer such that the option course is executed after a completion of the steam-enable course.

5. The dryer according to claim 3, wherein the option selector comprises at least one of a button for selecting an option to execute the option course during the steam-enable course, and a button for selecting an option to execute the steam cycle after the completion of the steam-enable course.

6. The dryer according to claim 3, wherein the steam-enable course is controlled to be executed under a condition in which an operation condition of the drying cycle is varied in accordance with a drying degree sensed during the drying cycle.

7. The dryer according to claim 6, wherein an amount of the object is determined, based on the sensed drying degree.

8. The dryer according to claim 7, wherein a point of time when a heater operates to generate steam is varied in accordance with the determined object quantity.

9. The dryer according to claim 8, wherein an operation time of the heater is varied in accordance with the determined object quantity.

10. The dryer according to claim 2, wherein the steam course includes a drying cycle for supplying hot air to the object container, to dry the object, and the steam cycle.

11. The dryer according to claim 10, wherein the steam course is controlled to be executed under a condition in which no variation in a predetermined operation condition of the drying cycle occurs during the drying cycle.

12. The dryer according to claim 10, wherein, when the steam course is selected, the option course is disabled so that the option course cannot be selected.

13. The dryer according to claim 10, wherein the steam course comprises a course in which the steam cycle is executed after a completion of the drying cycle such that the object has a moisture content of 5 to 6%.

14. The dryer according to claim 10, wherein the steam course comprises a course in which a drying cycle is executed after a completion of the steam cycle for the object, which is in a dry state.

15. The dryer according to claim 1, wherein, when the steam-off course is selected, the option course is disabled so that the option course cannot be selected.

16. The dryer according to claim 2, wherein an amount of steam supplied to the object in the steam cycle is varied in accordance with an amount of the object.

17. The dryer according to claim 16, wherein the control panel further comprises a button for selecting the amount of steam supplied to the object in the steam cycle, or a button for inputting information as to the object quantity.

18. The dryer according to claim 1, wherein the steam cycle supplies fine moisture to an interior of the object container, along with hot air, in place of steam.

19. The dryer according to claim 2, wherein the controller controls the operation of the dryer such that the selected operation course and the selected option course are executed in a sequential or simultaneous manner.

20. The dryer according to claim 1, wherein the control panel further comprises prints for visually distinguishing the steam-enable course, the steam course, and the steam-off course from one another.
